(19) United States
(12) Patent Application Publication
(10) Pub. No.: US 2009/0280571 A1
(43) Pub. Date: Nov. 12, 2009

(54) MICROELECTRONIC DEVICE WITH MAGNETIC MANIPULATOR

(75) Inventors: Jeroen Hans Nieuwenhuis, Waalre (NL); Johannes Wilhelmus Weekamp, Beek En Donk (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/305,395

(22) PCT Filed: Jun. 19, 2007
(86) PCT No.: PCT/IB07/52338

§ 371 Date: Dec. 18, 2008

(30) Foreign Application Priority Data
Jun. 29, 2006 (EP) 06116271.5

(51) Int. Cl. G01N 27/72; B03C 5/02

(52) U.S. Cl. 436/149; 422/99

(57) ABSTRACT

The invention relates to a microelectronic device, particularly to a magnetic biosensor (10) which comprises a magnetic field generator, e.g. a bonding wire (16), extending in a sample chamber (5) a distance (d) away from a reaction surface (14) of a substrate (15). In a preferred embodiment, the device comprises a magnetic sensor element, e.g. a GMR sensor (12), for detecting magnetized particles (2) bound to specific binding sites (3) at the reaction surface (14). Moreover, it may comprise integrated magnetic excitation wires (11, 13) for generating a magnetic excitation field (B) at the reaction surface (14). In a particular application of the device (10), the stringency of the binding of magnetic particles can be tested by generating an inhomogeneous magnetic manipulation field (Bₘₐₙ) with the magnetic field generator (16) in the sample chamber (5).

The invention relates to a microelectronic device, particularly a microelectronic magnetic sensor device for detecting magnetized particles. Moreover, it relates to a method for the manipulation of magnetic particles in a sample.

From the WO 2005/010543 A1 and WO 2005/010542 A2 (which are incorporated into the present application by reference) a microelectronic sensor device is known which may for example be used in a microfluidic biosensor for the detection of molecules, e.g. biological molecules, labeled with magnetic beads. The microsensor device is provided with an array of sensors comprising integrated wires for the generation of a magnetic excitation field and integrated Giant Magneto Resistances (GMR) for the detection of stray fields generated by magnetized beads. The signal of the GMRs is then indicative of the number of the beads near the sensor.

From the U.S. 2004/0219695 A1 it is further known to use magnetic or electric fields for attracting molecules labeled with magnetically or electrically interactive particles to binding sites and/or for removing unbound labeled molecules from a sensor region. The document does however not describe how the manipulation fields are generated.

Based on this situation it was an object of the present invention to provide a microelectronic device with means for the manipulation of magnetic particles, wherein it is desired that said means are easy to produce and provide well defined magnetic fields.

This objective is achieved by a microelectronic device according to claim 1 and a method according to claim 10. Preferred embodiments are disclosed in the dependent claims.

The microelectronic device according to the present invention is intended for the manipulation of magnetic particles, for example of beads that serve as labels of target molecules and that can be magnetized by appropriate magnetic excitation fields. The term “manipulation” shall denote any interaction with said particles, for example measuring characteristic quantities of the particles, investigating their properties, processing them mechanically or chemically or the like. The microelectronic device comprises the following components:

a) A sample chamber in which a sample with magnetic particles to be manipulated can be provided. The sample chamber is typically an empty cavity or a cavity filled with some substance like a gel that may absorb a sample substance; it may be an open cavity, a closed cavity, or a cavity connected to other cavities by fluid connection channels.

b) A substrate with a reaction surface, wherein said reaction surface forms one wall (including the bottom or top wall) of the aforementioned sample chamber. The substrate will typically be one of the usual carrier materials for integrated microelectronic circuits, for example a semiconductor like silicon. The term “reaction surface” shall indicate that mechanical, chemical, biological etc. reactions will typically take place in this region, though this needs not necessarily be the case.

c) At least one magnetic field generator that extends within the sample chamber at a distance from the reaction surface.

d) A power supply unit for providing the aforementioned magnetic field generator with electrical current, wherein said current is needed by the generator to produce the desired magnetic fields.

The described microelectronic device has the advantage to provide a magnetic manipulation field originating within the sample and reaching to the reaction surface, where it can for example exert forces on magnetic particles to move them or to break their bindings. The action of these magnetic manipulation fields can very flexibly and precisely be controlled via the power supply unit.

The magnetic field generator can be designed in such a way that it generates magnetic manipulation fields with the desired spatial configuration and/or magnitude that is appropriate for the underlying application of the device. In a preferred embodiment, the magnetic field generator is designed such that it generates a magnetic manipulation field at the reaction surface with a gradient that is substantially perpendicular to the reaction surface (i.e. the gradient vector is oriented at an angle of about 90°±20° with respect to the reaction surface). Moreover, the gradient is preferably directed away from the reaction surface, which means that the strength of the magnetic manipulation field increases with increasing distance from the reaction surface (or, equivalently, with decreasing distance from the magnetic field generator). The magnetic manipulation field generates in this case a force on magnetic particles that is perpendicular to the reaction surface and allows to move said particles efficiently away from the reaction surface.

The reaction surface of the microelectronic device preferably comprises binding sites that can (directly or indirectly) bind the magnetic particles. The magnetic particles can for example comprise biological target molecules that specifically bind to said binding sites. The amount of bound magnetic particles will in this case be an indication of the concentration of target molecules in the sample. It is an advantage of the microelectronic device that the stringency of the binding between the binding sites and the magnetic particles can readily be tested by generating a magnetic manipulation field which tends to break the binding; strong bindings can thus be distinguished from weaker bindings that are of no interest.

The dimensions of the microelectronic device have to be fitted to the desired application. In a preferred embodiment, the free distance between the magnetic field generator and the reaction surface (i.e. the minimal distance that can be assumed between a point on the reaction surface and a point within the magnetic field generator) is by a factor between 0.2 and 5 times larger than the diameter of the magnetic field generator (the latter typically being measured in the same plane as the aforementioned free distance and/or perpendicular to the direction of current flow through the magnetic field generator).

There are many possible realizations of the magnetic field generator, for example by micro-coils. In a preferred embodiment, the magnetic field generator comprises a straightly extending conductor, particularly an oblong metal strip or wire. If the current flows parallel to the extension of this conductor, it will generate a magnetic manipulation field that is approximately homogeneous in the axial direction and inhomogeneous in radial direction (e.g. decreasing with increasing distance from the conductor axis).

In the aforementioned case, the conductor is preferably realized by a microelectronic bonding wire. The fabrication of bonding wires is a standard step in the production of integrated circuits. This can be exploited to produced the magnetic field generator in an efficient and cost-effective way. The technique of bonding and appropriate materials has been described in literature (cf. Bob Chylak, Lee Levine, Stephen Babinetz, O.D. Kwon, “Advanced Ultra-Low-Loop Wire Bonds” (presented at SEMICON China 2006), which is incorporated into the present application by reference).

While the conductor can in principle be arbitrarily oriented in the sample chamber, it is preferred that it extends parallel to the reaction surface. In this case, the current will flow through the conductor substantially parallel to the reaction surface, too, thus generating a magnetic manipulation field with a gradient substantially perpendicular to said surface.

According to a further development of the invention, the microelectronic device comprises a magnetic sensor element that is located on or in the substrate. The magnetic sensor element may for example comprise a Hall sensor or a magneto-resistive element like a GMR (Giant Magneto Resistance), a TMR (Tunnel Magneto Resistance), or an AMR (Anisotropic Magneto Resistance) element. Moreover, the magnetic sensor element can be any suitable sensor element based on the detection of the magnetic properties of particles to be measured on or near to the sensor surface. Therefore, the magnetic sensor element is designable as a coil, magneto-resistive sensor, magneto-restrictive sensor, Hall sensor, planar Hall sensor, flux gate sensor, SQUID (Semiconductor Superconducting Quantum Interference Device), magnetic resonance sensor, or as another sensor actuated by a magnetic field. The magnetic sensor element allows to detect magnetized particles in the sample chamber, particularly magnetized particles that are bound to the reaction surface. If the magnetic sensor element is an oblong component, e.g. a resistance, extending in a certain axial direction, then the conductor of the magnetic field generator preferably extends parallel to this axis. Moreover, it is preferred that the diameter of the magnetic field generator (measured in one particular or, alternatively, in an arbitrary direction) is larger than the corresponding diameter (i.e. the diameter lying in the same direction) of the magnetic sensor element. The magnetic field generator will then overlap the magnetic sensor element, providing that the magnetic manipulation field is approximately homogeneous in the considered direction of the magnetic sensor element.

According to a further development of the invention, the microelectronic device comprises at least one further magnetic field generator that is located on or in the substrate. Embedded magnetic field generators can for example be used to generate a magnetic excitation field at the reaction surface that magnetizes particles bound there.

The invention further relates to a method for the manipulation of magnetic particles, comprising the following steps:

a) Providing a sample that comprises magnetic particles to a sample chamber.

b) Supplying a current to a magnetic field generator that extends inside the sample chamber for generating an inhomogeneous magnetic field around said magnetic field generator.

The method comprises in general form the steps that can be executed with a microelectronic device of the kind described above. Therefore, reference is made to the preceding description for more information on that method.

These and other aspects of the invention will be apparent from and elucidated with reference to the embodiment(s) described hereinafter. These embodiments will be described by way of example with the help of the accompanying drawings in which:

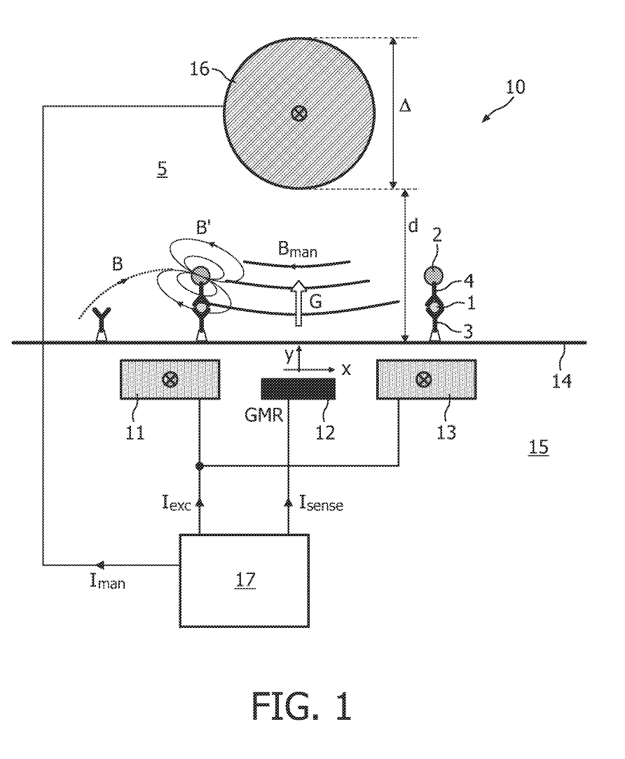

FIG. 1 shows a schematic cross section of a microelectronic magnetic sensor device according to the present invention;

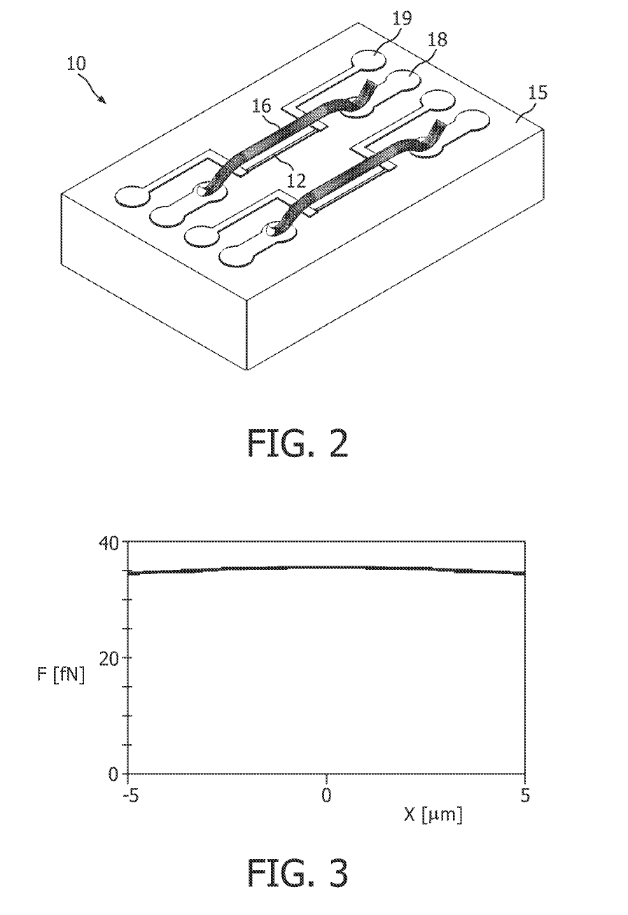

FIG. 2 shows a schematic perspective view of the device of FIG. 1 realized with bonding wires;

FIG. 3 shows in a diagram the magnetic attraction force exerted on a test particle in dependence on its position on the reaction surface.

Like reference numbers in the Figures refer to identical or similar components.

FIG. 1 illustrates the principle of a single microelectronic sensor 10 for the detection of superparamagnetic beads 2. A biosensor consisting of an array of (e.g. 100) such sensors 10 may be used to simultaneously measure the concentration of a large number of different target molecules 1 (e.g. protein, DNA, amino acids, drugs of abuse) in a solution (e.g. blood or saliva) that is provided in a sample chamber 5. In one possible example of a binding scheme, the so-called “sandwich assay”, this is achieved by providing a “reaction surface” 14 with first antibodies 3 to which the target molecules 1 may bind. Superparamagnetic beads 2 carrying second antibodies 4 may then attach to the bound target molecules 1. It should be noted that the described process is, in the context of the present application, simply referred to as “binding of magnetic particles to specific binding sites on the reaction surface”.

The sensor 10 further comprises a substrate 15, for example silicon, into which excitation wires 11, 13, a GMR sensor 12, and optionally also a power supply circuit 17 are integrated. A total current I_{exc}, flowing in the parallel excitation wires 11 and 13 of the sensor 10 generates a magnetic excitation field B, which then magnetizes the superparamagnetic beads 2 on the reaction surface 14. The reaction field B′ from the superparamagnetic beads 2 introduces an in-plane magnetization component in the GMR 12 of the sensor 10, which results in a measurable resistance change that is sensed via a sensor current Iₛₑₙₛₑ. The mentioned currents I_{exc} and Iₛₑₙₛₑ are supplied by a power supply unit 17 (wherein returning leads have been omitted in the drawing for clarity).

The sensor 10 can be any suitable sensor 10 to detect the presence of magnetic particles on or near to a sensor surface, based on any property of the particles, e.g. it can detect via magnetic methods, e.g. magnetoresistive, Hall, coils. The sensor 10 can detect via optical methods, for example imaging, fluorescence, chemiluminescence, absorption, scattering, surface plasmon resonance, Raman spectroscopy etc. Further, the sensor 10 can detect via sonic detection, for example surface acoustic wave, bulk acoustic wave, cantilever deflections influenced by the biochemical binding process, quartz crystal etc. Further, the sensor 10 can detect via electrical detection, for example conduction, impedance, amperometric, redox cycling, etc.

In case of a magnetic sensor 10 this can be any suitable sensor 10 based on the detection of the magnetic properties of particles to be measured on or near to the sensor surface. Therefore, the sensor 10 is designable as a coil, magneto-resistive sensor 10, magneto-restrictive sensor 10, Hall sensor 10, planar Hall sensor 10, flux gate sensor 10, SQUID (Semiconductor Superconducting Quantum Interference Device), magnetic resonance sensor 10, or as another sensor 10 actuated by a magnetic field.

In the described assay the amount of target molecules 1 is quantified by attaching magnetic labels (i.e. the beads 2 with the antibodies 4) to the target molecules 1 on the surface 14 of the biosensor. Besides the magnetic labels that bind specifically to the target molecules, also other magnetic labels might stick to the surface. A stringency step is therefore required to remove these non-specifically bound labels from the surface, before the number of specifically bound labels can be accurately measured.

The traditional way to remove the non-specifically bound labels is by a washing step in which a liquid is forced over the surface of the chip. However, this is not very attractive for a point of care application, since it requires an additional fluidic handling step. It is therefore proposed here to remove the non-specifically bound magnetic labels by using a magnetic field (gradient) to exert a magnetic manipulation force.

While it is possible to generate a magnetic manipulation field by an external coil, this approach seems to be not very favorable since the magnetic field needs to be very accurately aligned with respect to the sensor cartridge. An integrated solution will therefore be described here as preferred embodiment. This integrated solution comprises a magnetic field generator that is realized in the example of FIG. 1 by a conductor wire 16 which extends within the sample chamber 5 parallel to the GMR sensor 12 at a free distance d above the reaction surface 14. The conductor wire 16 is connected to the power supply unit 17 which provides it with a “manipulation current” Iₘₐₙ (wherein the returning leads to the power supply unit are again left out for clarity).

FIG. 2 shows a perspective view of the sensor 10 in which the conductor wire is favorably realized by a bonding wire 16 that extend between contact pads 19 on the surface of the substrate 15 within the sample chamber and parallel to the GMR sensor 12 (the excitation wires 11, 13 are not shown for clarity in FIG. 2). Attaching bonding wires to a chip is a standard fabrication step in IC-manufacturing and can therefore be fairly easy integrated in the fabrication process of the biosensor.

When a current is passed through the bonding wires 16, a radial magnetic field Bₘₐₙ is generated which has a gradient G orthogonal to the surface 14 of the chip. As a result the magnetic beads 2 experience a force perpendicular to the sensor surface 14, i.e. towards the bonding wire 16.

The typical distance d between the sensor surface 14 and the bonding wire 16 should be in the order of 20-30 μm to ensure that the magnetic labels are pulled away far enough from the GMR sensor 12. Bonding wire typically has a thickness of about 25 μm. The combination of the dimensions of the bonding wire and distance between the bonding wire and the sensor results in a force exerted on beads 2 on the sensor surface that is very uniform over the width of the sensor (typically 10 μm).

This is illustrated in the diagram of FIG. 3, which shows the little variation of the force F with which a magnetic test particle (300 nm diameter, Iₘₐₙ=1A) is attracted at various x-positions on the reaction surface 14 above the GMR sensor 12.

It should be noted that the magnetic excitation wires 11, 13 that are integrated into the substrate 15 are not very suited for the generation of magnetic manipulation fields as they exert rather non-uniform forces on the magnetic particles 2 due to their different positioning with respect to said particles. Moreover, the wires 11, 13 could only generate forces that attract magnetic particles 2 to the reaction surface 14.

Whereas in the above description only the application of magnetic washing based on the bonding wires 16 has been described, of course other types of magnetic manipulation can be realized with the bonding wires, too.

In summary, it was proposed to use conductor wires, particularly bonding wires, extending parallel to the surface of the substrate of a magnetic biosensor for generating a magnetic field gradient that allows to manipulate magnetic particles. Thus for example a stringency test can be provided. Advantages of this approach and the described specific embodiments are:
a magnetic manipulation field is created that has a strong gradient;
the magnetic manipulation field is very uniform over the sensor surface;
the bonding wire is an integrated solution, so the magnetic manipulation field is well aligned to the sensor;
adding bonding wires is compatible to the fabrication of the biosensor;
bonding wires are a available in standard IC-fabrication processes.

Finally it is pointed out that in the present application the term “comprising” does not exclude other elements or steps, that “a” or “an” does not exclude a plurality, and that a single processor or other unit may fulfill the functions of several means. The invention resides in each and every novel characteristic feature and each and every combination of characteristic features. Moreover, reference signs in the claims shall not be construed as limiting their scope.

1. A microelectronic device (10) for the manipulation of magnetic particles (2), comprising:
a) a sample chamber (5);
b) a substrate (15) with a reaction surface (14) that forms one wall of the sample chamber (5);
c) at least one magnetic field generator (16) that extends within the sample chamber (5) at a distance (d) from the reaction surface (14);
d) a power supply unit (17) for providing the magnetic field generator (16) with electrical current (Iₘₐₙ).

2. The microelectronic device (10) according to claim 1,
characterized in that the magnetic field generator (16) is adapted to generate a magnetic manipulation field (Bₘₐₙ) at the reaction surface (14) with a gradient (G) substantially perpendicular to the reaction surface (14).

3. The microelectronic device (10) according to claim 1,
characterized in that the reaction surface (14) comprises binding sites (3) for the magnetic particles (2).

4. The microelectronic device (10) according to claim 1,
characterized in that the free distance (d) between the magnetic field generator (16) and the reaction surface (14) has a value that ranges between 0.2 and 5 times the diameter (A) of the magnetic field generator (16).

5. The microelectronic device (10) according to claim 1,
characterized in that the magnetic field generator comprises a straightly extending conductor (16).

6. The microelectronic device (10) according to claim 5,
characterized in that the conductor is realized by a microelectronic bonding wire (16).

7. The microelectronic device (10) according to claim 5,
characterized in that the conductor (16) extends parallel to the reaction surface (14).

8. The microelectronic device (10) according to claim 1,
characterized in that it comprises a magnetic sensor element (12) located on or in the substrate (15).

9. The microelectronic device (10) according to claim 1,
characterized in that it comprises a further magnetic field generator (11, 13) located on or located in the substrate (15).

10. A method for the manipulation of magnetic particles (2), comprising
a) providing a sample chamber (5) with a sample comprising magnetic particles (2);
b) supplying a current (Iₘₐₙ) to a magnetic field generator (16) that extends inside the sample chamber (5) for generating an inhomogeneous magnetic field (Bₘₐₙ) around said magnetic field generator (16).
